(19) United States
(12) Patent Application Publication
(10) Pub. No.: US 2020/0255053 A1
(43) Pub. Date: Aug. 13, 2020

(54) WORM SHAFT FOR STEERING ASSEMBLY

(71) Applicant: STEERING SOLUTIONS IP HOLDING CORPORATION, Saginaw, MI (US)

(72) Inventor: Terence L. Horstman, Frankenmuth, MI (US)

(21) Appl. No.: 16/784,925

(22) Filed: Feb. 7, 2020

Related U.S. Application Data
(60) Provisional application No. 62/804,481, filed on Feb. 12, 2019.

(51) Int. Cl. B62D 3/04

(52) U.S. Cl. CPC B62D 3/04; B62D 5/04

(57) ABSTRACT

A worm shaft for a steering assembly includes a first end. The worm shaft also includes a second end located opposite the first end. The worm shaft further includes a middle portion between the first end and the second end, the middle portion including a plurality of teeth, each tooth of the plurality of teeth defining a pair of flank segments extending from a tooth base and meeting at a tip region, the pair of flank segments defining a non-continuously curving geometry within the tip region.

### CROSS-REFERENCE TO RELATED APPLICATION

This application claims priority to U.S. Provisional Patent Application No. 62/804,481, filed on Feb. 12, 2019, the disclosure of which is incorporated by reference herein in its entirety.

### BACKGROUND

Vehicles typically employ a power steering system as a component of a steering assembly. The power steering system may provide a torque assist to a steering column and steering wheel via a worm assembly. The worm assembly may include a worm shaft and a worm gear. Teeth of the worm shaft and worm gear wear over time as a result of operation cycles and the wear negatively impacts performance of the power steering system.

### SUMMARY

According to one aspect of the disclosure, a worm shaft for a steering assembly includes a first end. The worm shaft also includes a second end located opposite the first end. The worm shaft further includes a middle portion between the first end and the second end, the middle portion including a plurality of teeth, each tooth of the plurality of teeth defining a pair of flank segments extending from a tooth base and meeting at a tip region, the pair of flank segments defining a non-continuously curving geometry within the tip region.

According to another aspect of the disclosure, a worm assembly for a steering assembly includes a worm shaft including a first plurality of teeth to define a threaded portion of the worm shaft. The worm assembly also includes a worm gear including a second plurality of teeth for meshing with the first plurality of teeth, each tooth of the plurality of teeth defining a pair of flank segments extending from a tooth base and meeting at a tip region, the pair of flank segments defining a non-continuously curving geometry within the tip region.

These and other advantages and features will become more apparent from the following description taken in conjunction with the drawings.

### BRIEF DESCRIPTION OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view illustrating an example of a portion of a steering assembly shown within a vehicle;

FIG. 2 is a side view illustrating an example of a worm shaft;

FIG. 3 is a perspective exploded view illustrating an example of a portion of a steering assembly including a worm shaft;

FIG. 4 is a perspective view illustrating an example of a worm gear for use with the portion of the steering assembly of FIG. 3;

FIG. 5 is a side view of a prior art tooth of a worm shaft;

FIG. 6 is a side view of the prior art tooth of FIG. 5 illustrating an example of discontinuity formed at a transition from a flank to a tip region of the tooth;

FIG. 7 is a side view illustrating an example of a tooth of the worm shaft of FIGS. 2 and 3; and

FIG. 8 is a side view illustrating alternate detail of the tooth of FIG. 7.

### DETAILED DESCRIPTION

Referring now to the Figures, where the present disclosure will be described with reference to specific embodiments, without limiting same, it is to be understood that the disclosed embodiments are merely illustrative of the present disclosure that may be embodied in various and alternative forms. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

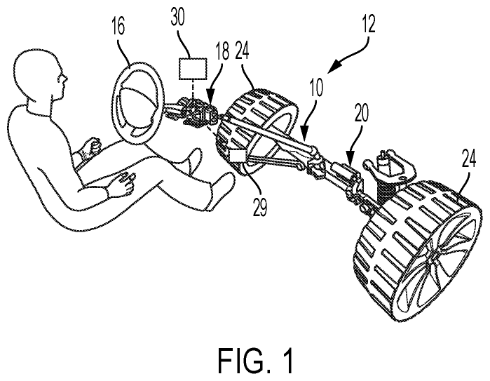

FIG. 1 illustrates an example of a steering assembly, referred to generally as a steering assembly 10 herein. The steering assembly 10 is shown disposed within a vehicle 12 in FIG. 1. The steering assembly 10 may assist in converting user inputs from a steering wheel 16 to direct movement of the vehicle 12. In this example, the vehicle 12 is a car, however, it is contemplated that the steering assembly 10 may be used to assist in steering other types of vehicles such as trucks, boats, aircraft, or other similar vehicles without departing from a scope of the present disclosure.

The steering assembly 10 may include the steering wheel 16 or other steering input device secured to an electric power steering assembly 18 for rotation. The electric power steering assembly 18 may be operatively connected to a rack and pinion assembly 20. The steering wheel 16, the electric power steering assembly 18, and the rack and pinion assembly 20 may be arranged with one another to direct movement of a front set of wheels 24 of the vehicle 12 based on a driver's input. For example, the rack and pinion assembly 20 may be operatively connected to each of the front set of wheels 24 via knuckles and tie rods to convey driver input from the steering wheel 16 for movement of each of the front set of wheels 24. Although the electric power steering assembly 18 is described above and illustrated as being connected to and employed in conjunction with a rack electric power steering assembly, it is to be appreciated that other types of electric power steering assemblies may benefit from the embodiments disclosed herein and are contemplated as being within the scope of the disclosed invention. For example, an assembly mounted to the steering column (i.e., column electric power steering) may be employed.

The steering assembly 10 may be in communication with a controller 29. The controller 29 may include programming to direct operation of components of the steering assembly 10 and/or to direct operation of other vehicle 12 components. The programming, for example, may output vehicle operation commands based on received signals and/or detected vehicle conditions.

Optionally, the steering assembly 10 may be in communication with a self-steering mechanism 30, such as an advanced driver assistance system (ADAS) or the like. The self-steering mechanism 30 may include programming to direct movement of the vehicle 12 without driver input to the steering wheel 16.

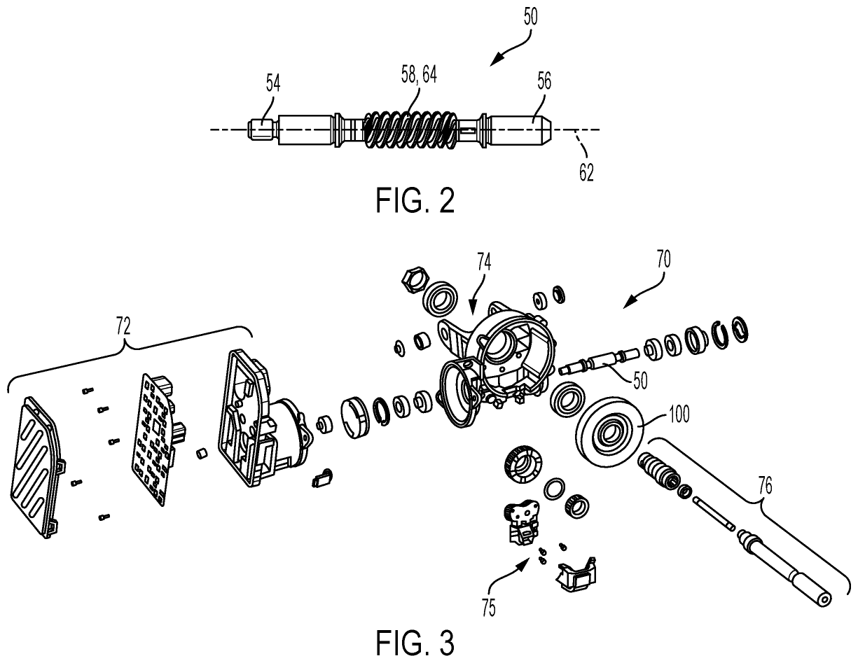

FIG. 2 is a side view illustrating an example of a worm shaft of a steering assembly, referred to generally as a worm shaft 50 herein. The worm shaft 50 may include a first end 54, a second end 56, and a middle portion 58 extending between the first end 54 and the second end 56. The first end 54 may include one or more knurls. Each of the one or more knurls may be spaced equidistant from a shaft central axis 62. The second end 56 may be located opposite the first end 54. The middle portion 58 may include a first plurality of teeth arranged to define a threaded region 64. The worm shaft 50 may operate with neighboring components to transfer torque from a motor assembly to a steering wheel to assist a driver with steering inputs as further described herein.

FIG. 3 is a perspective disassembled view illustrating an example of a portion of a steering assembly including the worm shaft 50, referred to generally as a power steering assembly 70 herein. The power steering assembly 70 may include the worm shaft 50, a motor assembly 72, an assist assembly 74, a sensor assembly 75, and a steering column assembly 76. The assist assembly 74, the worm shaft 50, the sensor assembly 75, and the steering column assembly 76 may operate with one another to transfer torque from the motor assembly 72 to another vehicle 12 component, such as a steering wheel or a steering column.

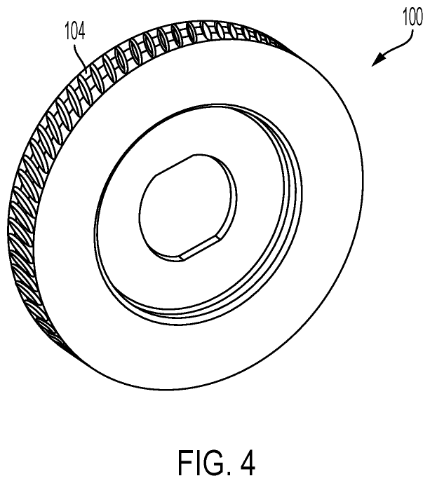

FIG. 4 is a perspective view illustrating an example of a worm gear of the steering column assembly 76, referred to generally as a worm gear 100 herein. The worm gear 100 may define a second plurality of teeth 104 sized and shaped to mesh with the first plurality of teeth of the worm shaft 50.

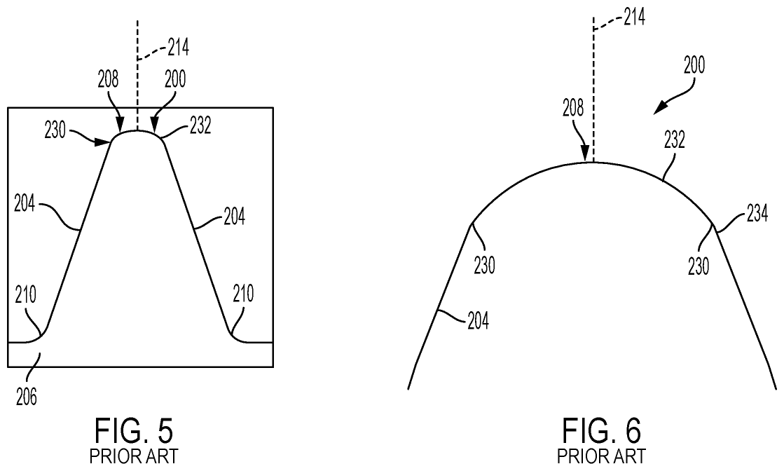

FIGS. 5 and 6 illustrate an example of a prior art design for a tooth of a worm shaft, referred to generally as a tooth 200 herein. The tooth 200 is representative of each of a plurality of teeth of a prior art worm shaft for meshing with teeth of a gear (gear not shown in FIGS. 5 and 6) in a prior art steering assembly. The tooth 200 includes a pair of flanks 204 extending from a base 206 and meeting at an apex region 208. In this example, a structure of the pair of flanks 204 and the apex region 208 present wear issues for the prior art worm gear that is in contact with the prior art worm shaft during an operation cycle. For example, a continuous arc between transition regions of the tooth 200 creates undesirable contact between each tooth 200 and respective gear teeth. The undesirable contact may generate interference between the tooth 200 and the respective gear teeth.

A burnish operation is an example of an operation in which two components contact one another and rub respective surfaces against one another. The burnish operation is typically executed as a surface treatment for components prior to assembly. As such, a worm shaft including teeth designed similar to the tooth 200 faces deformation prior to even being mounted within an assembly to assist in steering operations.

Each of the pair of flanks 204 extends from the base 206 at one of a pair of first transition regions 210. Each of the pair of first transition regions 210 may be spaced from one another to define a tooth width. A centerline 214 is defined along an axis spaced equidistant from each of the pair of first transition regions 210.

As mentioned above, each of the pair of flanks 204 meet at the apex region 208 defining a continuous arc. Each of the pair of flanks 204 extend to the apex region 208 via a respective one of a pair of second transition regions 230. Each of a pair of arc portions 232 of the apex region 208 extend from a respective one of the pair of second transition regions 230 such that the each of the pair of arc portions 232 meet one another at the apex region 208 defining a continuous arc. Each of the pair of arc portions 232 defines a radius equal to 0.6 millimeters.

FIG. 6 clarifies at least one issue with a design relationship of the prior art worm tooth and worm gear. For example, teeth of a worm gear may experience shearing due to undercutting and stresses from the teeth of the worm shaft during operation. The undercutting may be further aggravated at each of the second transition regions 230 resulting in respective discontinuity 234. Each of these discontinuities 234 impacts performance of the steering assembly including the prior art worm shaft and the prior art worm gear due to undesirable contact during meshed rotation.

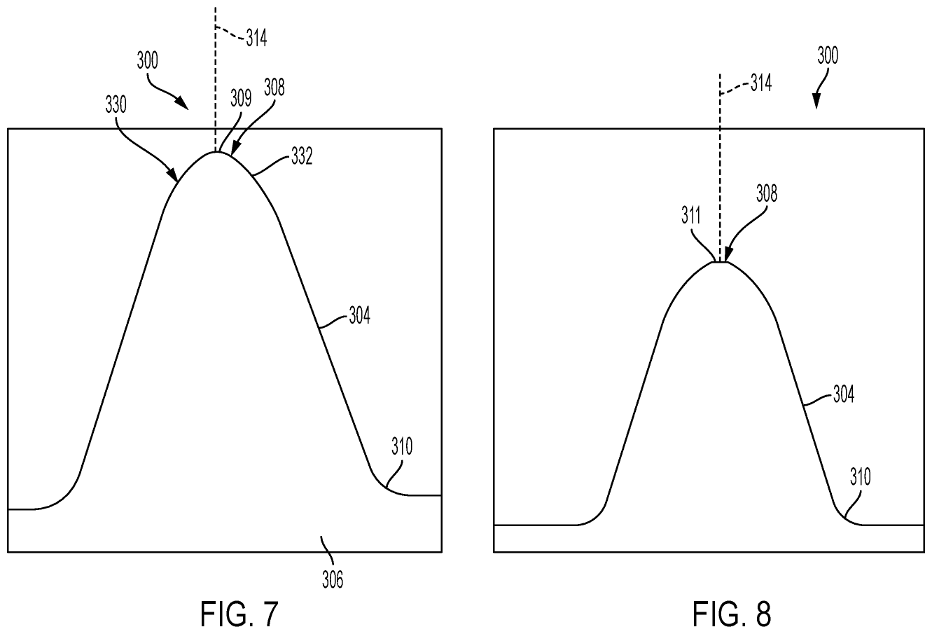

FIGS. 7 and 8 are side views illustrating examples of a tooth of a worm shaft for a steering assembly, referred to generally as a tooth 300 herein. The tooth 300 is an example of a tooth of the worm shaft 50 described above. The tooth 300 may include a pair of flank segments 304 extending from a base 306 and meeting at a tip region 308. It is contemplated that the pair of flank segments 304 may meet within the tip region 308 to define various shapes. Each of the various shapes define a non-continuous arc shape within the tip region 308. In FIG. 7, the pair of flank segments 304 are shown meeting at a point 309 and in FIG. 8 the pair of flank segments 304 are shown meeting at a plateau portion 311. In one example, each of the pair of flank segments 304 may extend from the base 306 at one of a pair of first transition regions 310.

A centerline 314 may be spaced equidistant from each of the pair of first transition regions 310. The centerline 314 may be defined along an axis spaced from each of the pair of first transition regions 310 a length equal to approximately half of a width of the tooth 300. In one example, a height of the tooth 300 may be substantially equal to 2.7 millimeters.

As mentioned above, each of the pair of flank segments 304 may meet at the tip region 308. Each of the pair of flank segments 304 may extend to the tip region 308 via a respective one of a pair of second transition regions 330. In this example, each of the pair of second transition regions 330 present a more gradual transition from the flank segment 304 to tip region 308 and do not define a discontinuity as a result of a burnish operation as described in relation to the tooth 200.

Each of a pair of arc portions 332 of the tip region 308 extend from a respective one of the pair of second transition regions 330 to the plateau portion 311. In one example, a length between the plateau portion 311 and each of the pair of second transition regions 330 is substantially equal to about 0.68 millimeters. Each of the pair of arc portions 332 may define a radius greater than about 0.6 millimeters and may be substantially equal to between 1 and 2 millimeters. In one example, a radius of each of the pair of arc portions 332 may be substantially equal to about 1.2 millimeters. In this example, the plateau portion 311 may define a length substantially equal to about 0.19 millimeters. It is contemplated that each of the arc portions 332 may meet at a point instead of the plateau portion 311 as shown in FIG. 7.

As described above, a structure of the tooth 300 of the worm shaft 50 alleviates negative issues related to wear on worm shafts and worm gears in worm assemblies of the prior art. The tooth 300 may be much less sensitive to distortion or deformation within the tip region 308 and thus provides an improvement in performance in comparison to prior art teeth such as the tooth 200. A larger radius of the arc portions 332 in comparison to the arc portions 232 assists in distributing a load and wear across a larger area of a respective worm tooth to extend an operational life of the worm assembly.

While aspects of the invention have been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the disclosure. Additionally, while various embodiments of the invention have been described, it is to be understood that aspects of the invention may include only some of the described embodiments. Accordingly, the invention is not to be seen as limited by the foregoing description.

Having thus described the present disclosure, it is claimed:

1. A worm shaft for a steering assembly comprising:
a first end;
a second end located opposite the first end; and
a middle portion between the first end and the second end, the middle portion including a plurality of teeth, each tooth of the plurality of teeth defining a pair of flank segments extending from a tooth base and meeting at a tip region, the pair of flank segments defining a non-continuously curving geometry within the tip region.

2. The assembly of claim 1, wherein the pair of flank segments meet within the tip region at respective edges of a plateau portion.

3. The assembly of claim 1, wherein the pair of flank segments meet within the tip region at a tip point.

4. The assembly of claim 1, wherein each tooth of the plurality of teeth further defines a first transition region between one of the pair of flank segments and the tip region, each tooth further defining a second transition region between the other of the pair of flank segments and the tip region, and each tooth further defining a pair of arc portions, each of the pair of arc portions extending from one of the transition regions.

5. The assembly of claim 4, wherein at least one of the arc portions is defined by a radius of curvature greater than 0.6 millimeters.

6. The assembly of claim 4, wherein at least one of the arc portions is defined by a radius of curvature of between 1 millimeter and 2 millimeters.

7. The assembly of claim 6, wherein each the radius of curvature is equal to 1.2 millimeters.

8. The assembly of claim 1, wherein each of the first plurality of teeth have a height of 2.7 millimeters.

9. The assembly of claim 3, wherein the plateau portion has a length of about 0.19 millimeters.

10. A worm assembly for a steering assembly comprising:
a worm shaft including a first plurality of teeth to define a threaded portion of the worm shaft; and
a worm gear including a second plurality of teeth for meshing with the first plurality of teeth, each tooth of the plurality of teeth defining a pair of flank segments extending from a tooth base and meeting at a tip region, the pair of flank segments defining a non-continuously curving geometry within the tip region.

11. The assembly of claim 10, wherein the pair of flank segments meet within the tip region at respective edges of a plateau portion.

12. The assembly of claim 10, wherein the pair of flank segments meet within the tip region at a tip point.

13. The assembly of claim 10, wherein each tooth of the first plurality of teeth further defines a first transition region between one of the pair of flank segments and the tip region, each tooth further defining a second transition region between the other of the pair of flank segments and the tip region, and each tooth further defining a pair of arc portions, each of the pair of arc portions extending from one of the transition regions.

14. The assembly of claim 13, wherein at least one of the arc portions is defined by a radius of curvature greater than 0.6 millimeters.

15. The assembly of claim 13, wherein at least one of the arc portions is defined by a radius of curvature of between 1 millimeter and 2 millimeters.

16. The assembly of claim 15, wherein each the radius of curvature is equal to 1.2 millimeters.

17. The assembly of claim 10, wherein each of the first plurality of teeth have a height of 2.7 millimeters.

18. The assembly of claim 11, wherein the plateau portion has a length of about 0.19 millimeters.
